(19) United States
(12) Patent Application Publication
(10) Pub. No.: US 2008/0026329 A1
(43) Pub. Date: Jan. 31, 2008

(54) SURFACE MODIFICATION OF POLYMER SURFACE USING ION BEAM IRRADIATION

(76) Inventors: Ashkan Vaziri, Cambridge, MA (US); Myoung-Woon Moon, Seoul (KR); Sang Hoon Lee, Seoul (KR); Jeong Yun Sun, JeonNam (KR); Kyu Hwan Oh, Seoul (KR)

Correspondence Address: GAUTHIER & CONNORS, LLP, 225 FRANKLIN STREET, SUITE 2300, BOSTON, MA, 02110, US

(21) Appl. No.: 11/781,476

(22) Filed: Jul. 23, 2007

Related U.S. Application Data
(60) Provisional application No. 60/833,337, filed on Jul. 26, 2006.

(51) Int. Cl. G03C 5/00

(52) U.S. Cl. 430/322

(57) ABSTRACT

A system and method for producing a plurality of controlled surface irregularities, such as wrinkles, is provided. The system includes a polymeric substrate. An irradiation source is positioned to provide a beam on desired areas of the polymeric substrate. The surface irregularities appear on the exposed region by controlling the relative motion of the polymeric substrate and the irradiation source when scanning the exposed region.

### PRIORITY INFORMATION

This application claims priority from provisional application Ser. No. 60/833,337 filed Jul. 26, 2006, which is incorporated herein by reference in its entirety.

### BACKGROUND OF THE INVENTION

The invention is related to the field of surface modification at micron and submicron scale, and in particular to controlled surface irregularities, such as wrinkles on polymer substrate using ion beam irradiation.

Modification of the surface of polymers at micron and submicron scales has direct implications for an array of scientific and technological areas from tissue engineering to building high-capacity memory storage devices. In tissue engineering, for example, certain aspects of cell behavior can be controlled by altering surface topology. Other potential applications include optical diffraction gratings and optical microlens, biosensors, and microfluidic devices.

### SUMMARY OF THE INVENTION

According to one aspect of the invention, there is provided a system for producing a plurality of controlled surface irregularities. The system includes a polymeric substrate. An irradiation source is positioned to provide a beam on an exposed region of the polymeric substrate. The surface irregularities appear on the exposed region by controlling the relative motion of the polymeric substrate and the irradiation source when scanning the exposed region.

According to another aspect of the invention, there is provided a method of producing a plurality of controlled surface irregularities. The method includes a providing polymeric substrate. Also, the method includes positioning a beam on desired areas of the polymeric substrate. The surface irregularities are produced on the exposed region by controlling the relative motion of the polymeric substrate and the irradiation source when scanning the exposed region.

### BRIEF DESCRIPTION OF THE DRAWINGS

FIG. 1A is a schematic diagram illustrating an arrangement for forming wrinkled patterns on a flat polydimethylsiloxane (PDMS) sheet; FIGS. 1B-1E are SEM diagrams illustrating wrinkling patterns formed in accordance with the invention;

FIG. 2A-2C are SEM diagrams illustrating wrinkles with various morphologies formed by a multiple scanning mode of Focused Ion Beam (FIB) with beam current of 1 nA;

FIG. 3A is a schematic diagram illustrating another arrangement for forming wrinkled patterns on selected areas of flat polydimethylsiloxane (PDMS) sheet; FIGS. 3B-3C are SEM diagrams illustrating herring-bone wrinkles and self-nested hierarchical patterns formed in accordance with the invention;

FIGS. 4A-4D are graphs demonstrating quantification of the characteristics of wrinkling patterns induced by FIB in accordance with the invention.

FIG. 5 is a graph demonstrating the dependence of the wrinkling morphology and wavelength on the ion beam parameter in accordance with the invention; and

FIGS. 6A-6D are SEM diagrams showing selective patterning of the PDMS surface using maskless patterning in accordance with the invention;

FIG. 7 is an optical microscopic diagram illustrating a wrinkle in the shape of randomly distributed herringbone using an Ar plasma ion beam.

### DETAILED DESCRIPTION OF THE INVENTION

The invention describes a technique of producing controlled surface irregularities, such as wrinkles on polymer substrate using focused ion beam (FIB) irradiation.

Various wrinkling patterns, ranging from simple one-dimensional structures to peculiar and complex hierarchical self-nested patterns, are generated on confined surface areas of a flat polydimethylsiloxane (PDMS) by varying the FIB fluence and area of exposure. By examining the chemical composition of the PDMS through the depth, one can show that a stiff skin forms on the surface of the PDMS upon exposure to FIB. This stiff skin tends to expand in the direction perpendicular to the direction of ion beam irradiation. The consequent equilibrium-strain mismatch between the stiff skin formed on the PDMS upon exposure to FIB and its substrate leads to formation of self-assembled wrinkles.

The induced strains can be quantified by examining the topography of the wrinkles and interpreting observations using a simple theory. The invention provides an effective, accessible and inexpensive technique to create highly-controlled wrinkles on desired surfaces of polymers in various applications.

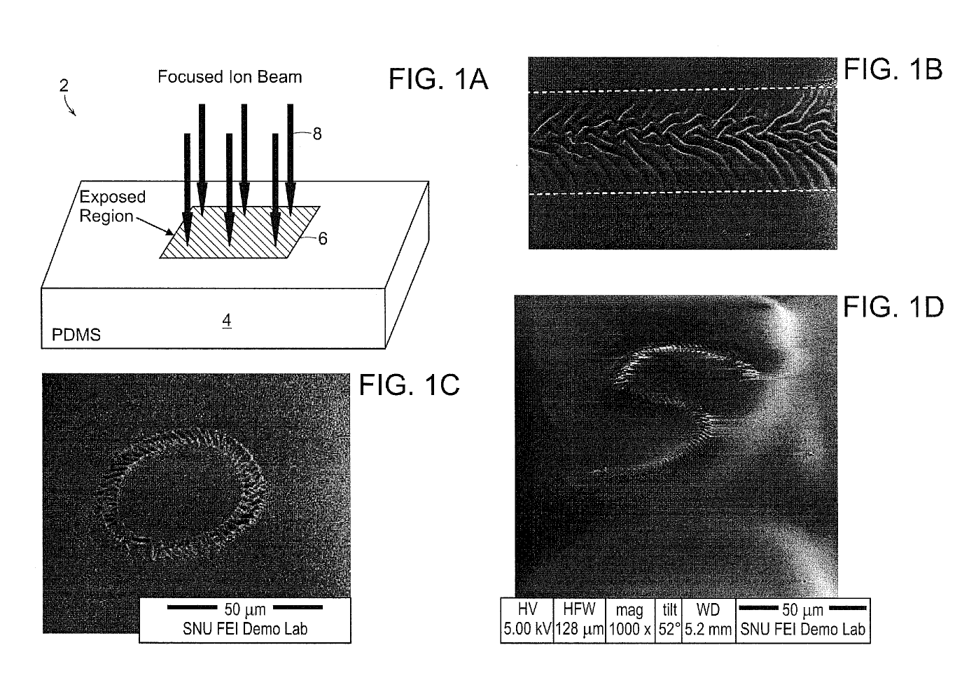

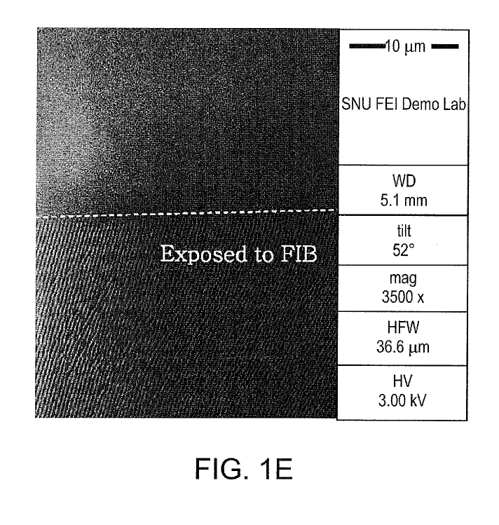

The wrinkling patterns presented in FIGS. 1B-1E are formed by using an arrangement 2 where an exposed the surface area 6 of a flat polydimethylsiloxane (PDMS) sheet 4 (thickness=3 mm, Young modulus ≈2 MPa) is exposed to a Focused Ion Beam (FIB) 8 of Ga+ as schematically shown in FIG. 1A. This technique allows creation of self-assembled wrinkles along complex paths with desired width as exemplified in FIGS. 1B-1E by controlling the relative motion of the polymeric substrate and the FIB to scan the desired area. In addition, the morphology of the wrinkles is controlled by the ion fluence.

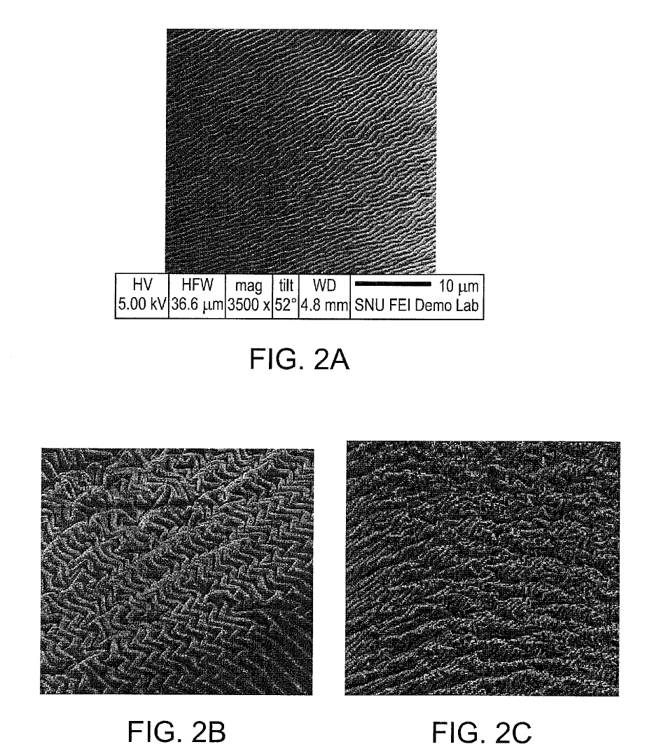

Wrinkles with various morphologies depicted in FIGS. 2A-2C are formed by a multiple scanning mode FIB scanning with beam current of 1 nA, which leads to the fluence in the range of 10¹³-10¹⁶ ions/cm². When the PDMS substrate is exposed to a FIB with fluence of ˜10¹³ ions/cm², the self-assembled wrinkles are mainly straight and one-dimensional with wavelength ˜460 nm, as shown in FIG. 2A. Herring-bone wrinkles and self-nested hierarchical patterns are created by decreasing the exposed area at the same ion current and consequently increasing the fluence, as shown in FIGS. 2B and 2C. In the pattern visualized in FIG. 2C for the fluence of 5.0×10¹³ ions/cm² the primary wrinkles with wavelength ≈450˜460 nm are nested on the larger secondary wrinkles with wavelength ≈1.9˜2.0 μm. The morphology of the wrinkles can also be controlled by tuning the number of FIB scans imposed to the PDMS substrate area.

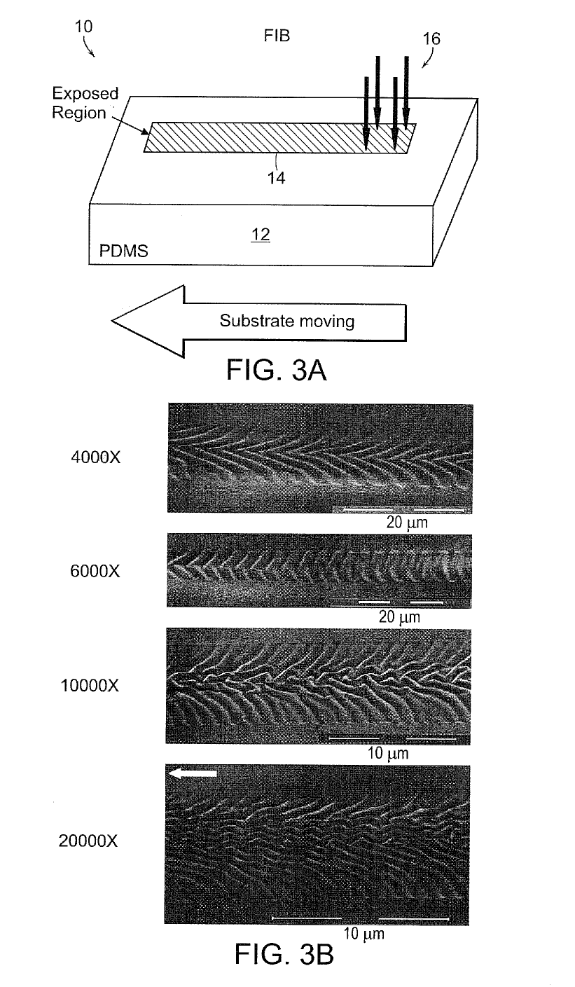

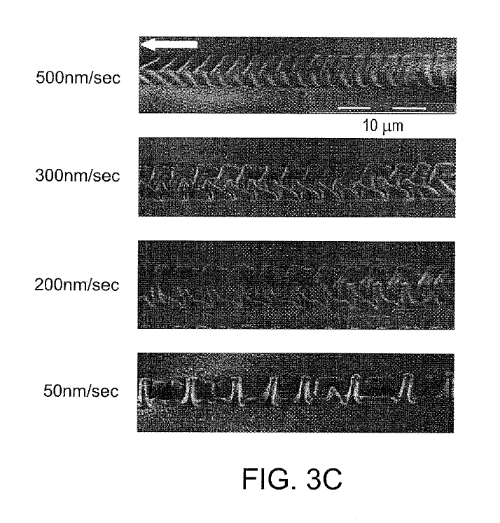

The wrinkles can be formed using an arrangement 10 where an exposed region 14 of a PDMS sheet 12 at a constant speed during FIB irradiation 16, as shown schematically in FIG. 3A. The wrinkling patterns shown in FIG. 3B are formed by moving the PDMS at a constant speed of 500 nm/sec while the FIB fluence is controlled by changing the width of the exposed area from 50 μm to 4 μm. In FIG. 3C the morphology of this self-assembled wrinkles are controlled by varying the speed of the PDMS substrate, while the width of exposed region is kept constant as 4 μm, which leads to the fluence of 2.0×10¹⁴˜2×10¹⁵ ions/cm².

The wrinkles appear on the exposed area of the PDMS just upon exposure to FIB indicating that the formation of the stiff skin is accompanied by an induced equilibrium-strain mismatch in the skin and its polymeric substrate. The stiff skin exposed to FIB tends to expand in the direction perpendicular to the direction of FIB irradiation, while constrained by the PDMS substrate. This leads to a mismatch between the equilibrium-strain of the stiff skin and its substrate, leading to formation of self-assembled wrinkles. This phenomenon is highly in contrast with UVO treatment of PDMS, where the generated stiff skin by proving additional cross-links is relatively strain-free.

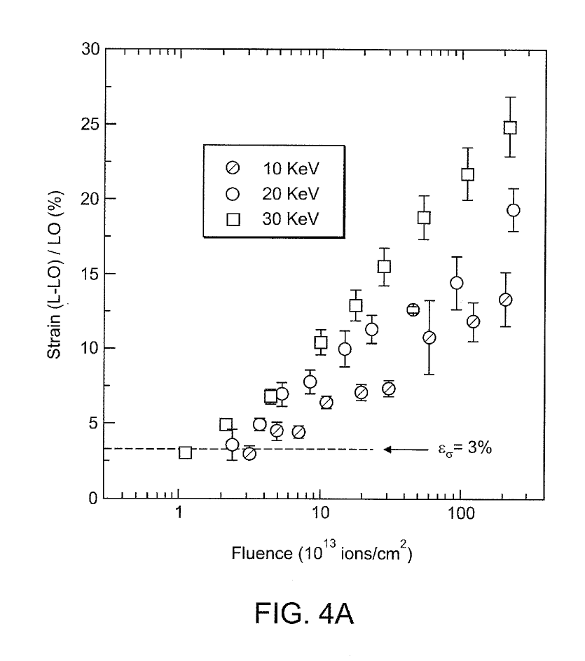

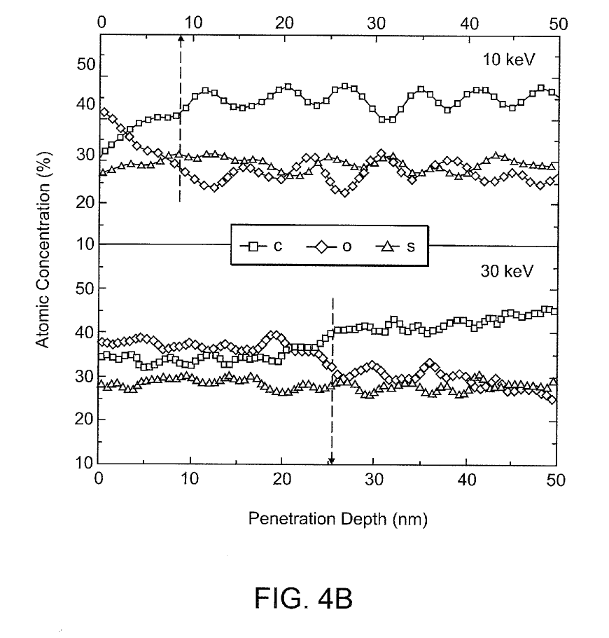

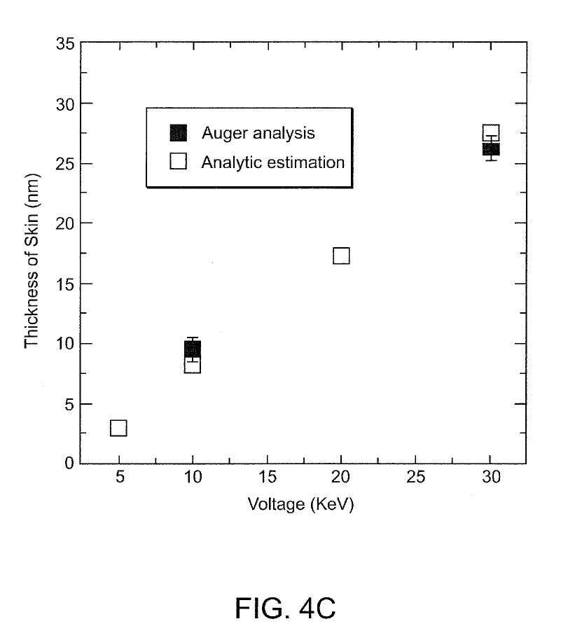

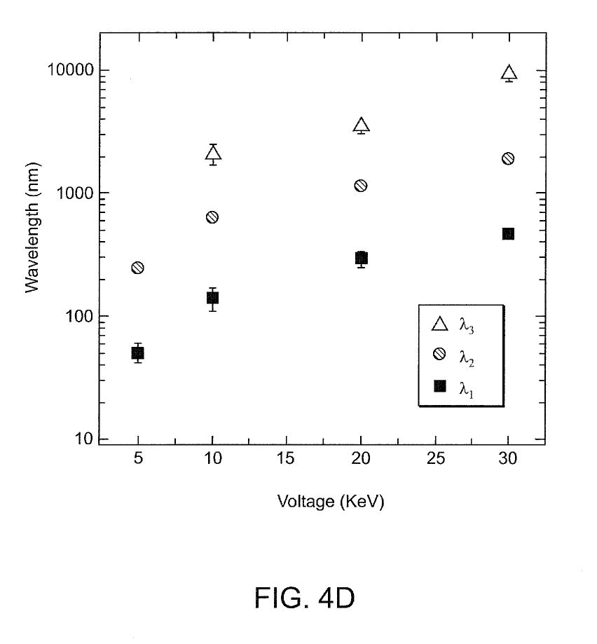

FIG. 4A shows the average induced strain in the stiff skin as a function of FIB fluence for the acceleration voltages 10, 20 and 30 keV, respectively. The induced strain in the stiff skin induced by FIB irradiation was estimated by direct measurement of the surface length, L, along a trace across the surface. With L₀ as the straight-line distance between the ends of the trace, the strain approximation is taken as (L−L₀)/L₀. The average compressive strain in the stiff skin was calculated by averaging the strain along at least 5 traces for each morphology studied. The lowest ion fluence which causes appearance of one-dimensional straight buckles is in the order of 10¹³ ions/cm² with a slight dependence on the acceleration voltage.

The average induced strain at the onset of skin wrinkling is ε_{c}˜3% for the three sets of measurement shown in FIG. 4A. Examination of the wrinkling patterns created by ion beam with acceleration voltage of 5 keV and 20 keV, confirmed that the induced average strain in the skin at the onset of wrinkling formation is effectively independent of the ion beam acceleration voltage. The classical relationship for buckling of a linear elastic stiff skin with modulus, Eₛ, attached to a compliant substrate with elastic modulus, E_{f}, gives the critical strain associated with the onset of instability as ε_{c}≈0.52(Eₛ/E_{f}), independent of the skin thickness. Based on ε_{c}˜3%, the modulus ratio is (Eₛ/E_{f})≈70. The associated wavelength, λ₁, of the first wrinkles to form, referred to hereafter as the primary wrinkles, scales with the thickness of the stiff skin, t, according to λ₁/t_{┌}4(E_{f}/Eₛ)^{1/3}.

The chemical composition of the region of the PDMS exposed to FIB for 10 and 30 keV, specifically, the concentration of three major chemical components of the PDMS, O, Si, and C, was examined using AES with a 2 keV electron beam and depth resolution of less than 2 nm. A depth profile for the chemical components was obtained using a controlled sputtering rate of 5.1 nm/min, calibrated by comparison to the sputtering rate of SiO₂.

The results of this analysis are shown in FIG. 4B for the substrate exposed to FIB with acceleration voltage of 10 and 30 keV and ion fluence of about 10¹³ ions/cm². In the region next to the surface the chemical composition is altered from the PDMS substrate taking a form somewhat similar to silica. By gauging the thickness of this altered region for the two acceleration voltages above, one arrives at the estimates of the thickness of the stiff skin in FIG. 4C. The analytical thickness estimates in FIG. 4C follow from using E_{f}/Eₛ≈70 and the measured primary wavelength λ₁, in t=λ₁/4(E_{f}/Eₛ)^{1/3}. In the range of ion fluence considered, the skin thickness increases approximately linearly with the acceleration voltage from ˜2.5 nm to ˜28 nm.

Close examination of the undulations also shows that the wavelengths of the patterns depend primarily on the acceleration voltage. A critical ion fluence is required to produce a given pattern, but the fluence has little effect on the wavelength once the pattern has formed. These observations are consistent with the notion that the acceleration voltage sets the depth of penetration of the ions and therefore the thickness of the stiff skin, while the lateral strain induced by the FIB is controlled by the fluence. The three wavelengths plotted as a function of acceleration voltage in FIG. 4D are measured within the hierarchical regime. The finest wrinkling pattern has λ₁≈50 nm and was created with an acceleration voltage 5 keV, while the wrinkling patterns induced by an acceleration voltage 30 keV have λ₁≈450 nm. The largest measured wavelength is λ₃≈10 μm for a hierarchical pattern induced by an acceleration voltage 30 keV.

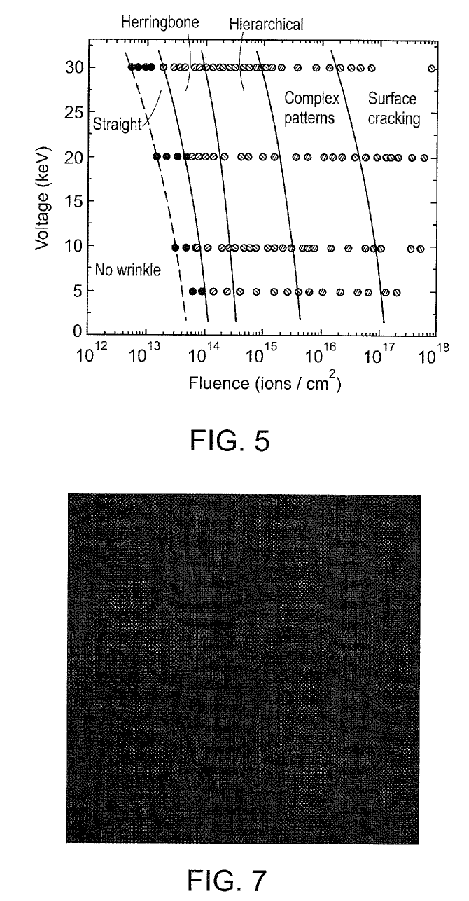

FIG. 5 is a graph demonstrating the dependence of the wrinkling morphology and wavelength on the ion beam parameter in accordance with the invention. In particular, FIG. 5 shows a relationship of wrinkle morphology as a function of FIB acceleration voltage and ion beam fluence. The wrinkling patterns were classified in five different categories: Straight, Herringbone, Hierarchical, Complex patterns and Surface cracking. The filled circles show the actual data for which the morphology of the created wrinkles was examined.

A significant advantage of the surface modification offered by the technique discussed here is that wrinkles appear only on the areas of the PDMS exposed to the FIB. Areas covered by wrinkles can be selected by simply controlling the motion of the ion beam relative to the substrate. The capabilities of this technique have been extend further by adopting the maskless patterning method of the FIB equipment. This method permits the accurate selection of the areas exposed to the FIB. Bitmap files of the exposure patterns are imported as a virtual mask in the focused ion beam system. Surface areas (20 μm×20 μm) of the PDMS substrate were subject to FIB irradiation with acceleration voltages of 10 keV.

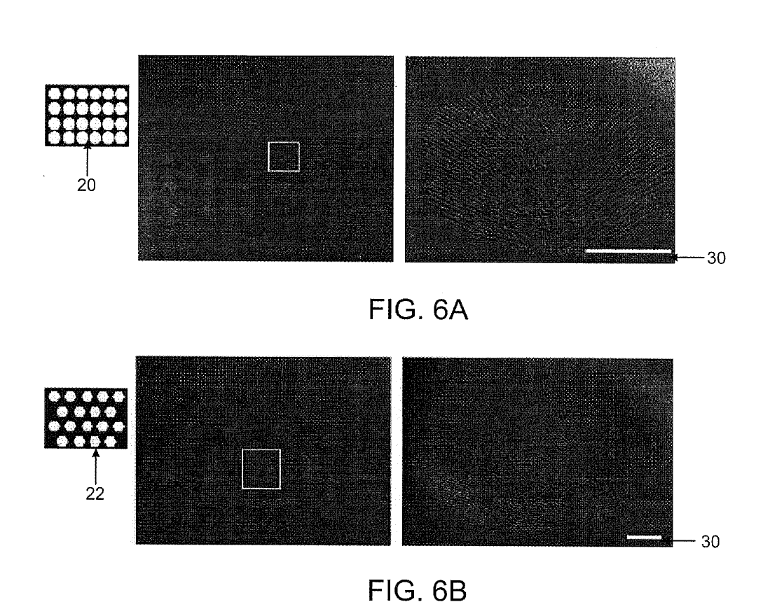

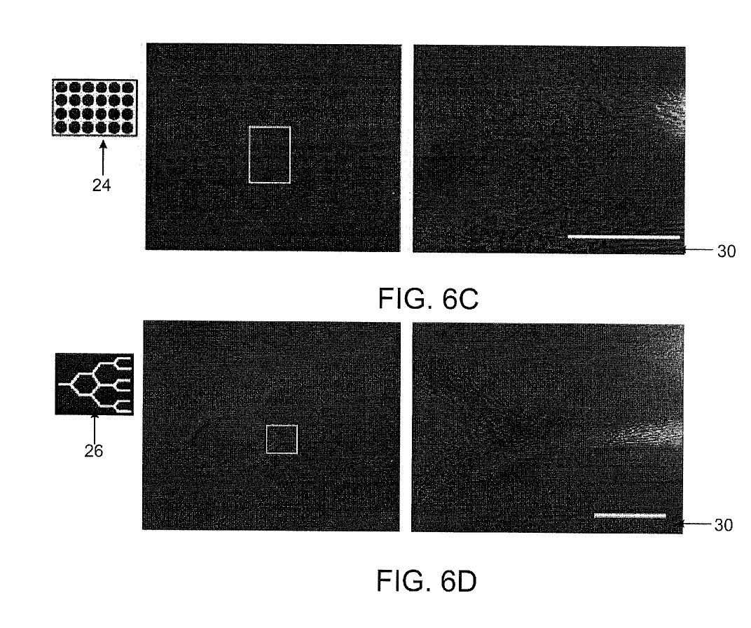

FIGS. 6A-6D show selective patterning of a PDMS surface using maskless patterning. The bitmap files 20-26 are imported to the FIB such that only the white regions are exposed. Using a low energy ion beam of acceleration voltage, 10 keV, wrinkling patterns with wavelength ˜120 nm and amplitude of 5-30 nm are created on the exposed regions of the PDMS substrate. The ion fluence of the FIB within each pattern shape is 1.3×10¹⁵, 2.1×10¹⁶, 2.25×10¹⁵, and 2.3×10¹⁵ ion/cm² for FIGS. 6A-6D respectively. FIGS. 6A-6D each includes SEM diagrams of the wrinkles themselves over areas within a white rectangle 30 (bar=5 μm).

The expansion of the focused ion beam irradiation onto PDMS surfaces are made possible with usage of broad ion beam using CVD method or broad ion beam generation technique, which could produced similar surface morphologies on polymer substrates as described below. The application of the ion beam irradiation on soft polymer substrate is following. Broad ion beam decomposed of Ar gas using PECVD (plasma enhanced CVD) has been irradiated on PDMS surface with 5 cm×5 cm×3 mm in size as described in FIG. 1A. The experimental condition for PECVD method is set for the negative self bias accelerating voltages ranged 100 to 900V and ion beam plasma currents ranged of 0.1 to 0.5 A, producing the power of 10 to 450 W under the gas pressure of 1.33˜133 pa. Here deposition time is also controlled for the changing the total ion fluence.

The image in FIG. 7 shows wrinkle in the shape of randomly distributed herringbone pattern with about 250 nm wavelength. Accelerating voltages and currents were set as 400V and 0.2 A with 10 minutes exposure of PDMS to Ar plasma ion beam. This technique would expand the application of ion beam induced surface morphologies in mass-production system sine the no limit of the specimen size which exposed to ion beam would be required in the methods. The wrinkle pattern shapes and geometries (composed of amplitude and wavelength) is also controllable with combination of the energy of ion beam and its expose times. However, in other embodiments of the invention O+ plasma ion bean can be used as well.

The invention provides a technique for producing an appearance of wrinkling patterns on a polymeric substrate upon exposure to ion beam (focused or broad). Also, the invention utilizes FIB irradiation to alter the chemical composition of the polymer close to its surface and induces a thin stiff skin. Self-assembled wrinkles appear on the surface area of the polymer exposed to FIB as this thin stiff skin undergoes in-plane compressive strains. The pattern could be generated along a desired path with desired width by controlling the relative movement of the ion beam and polymeric substrate providing a very simple way to attain the desired overall shape, while the wavelength and amplitude of wrinkles can be controlled in the range of microns and sub-microns by varying the ion beam fluence.

The phenomenon studied here provides a simple and inexpensive technique for creating surface irregularities, such as wrinkles, on polymers with desired morphology and shape. These patterns have potential technological applications such as building biological sensors, controlled patterning of polymer surfaces for example for optical diffraction grating and developing multi-functional fluidic devices in micron and submicron level.

Although the present invention has been shown and described with respect to several preferred embodiments thereof, various changes, omissions and additions to the form and detail thereof, may be made therein, without departing from the spirit and scope of the invention.

What is claimed is:

1. A system for producing a plurality of controlled surface irregularities comprising:
a polymeric substrate; and
an irradiation source positioned to provide a beam on an exposed region of said polymeric substrate; wherein
said surface irregularities appear on said exposed region by controlling the relative motion of said polymeric substrate and said irradiation source when scanning the exposed region.

2. The system of claim 1, wherein said irradiation source comprises Focused Ion Beam (FIB) or Broad Ion Beam (BIB).

3. The system of claim 2, wherein said FIB or BIB comprises of Ga+ or Ar+ or O+.

4. The system of claim 2, wherein said polymeric substrate comprises a flat polydimethylsiloxane (PDMS) sheet.

5. The system of claim 4, wherein said irradiations source controls the morphology of said surface irregularities by tuning the number of FIB scans imposed on the PDMS sheet.

6. The system of claim 4, wherein said surface irregularities appear by moving the polymer sheet at a constant speed during FIB irradiation.

7. The system of claim 4, wherein said surface irregularities are formed using one or more maskless patterns.

8. A method of forming a plurality of controlled self-assembled surface irregularities comprising:
providing a polymeric substrate;
positioning a beam on an exposed region of said polymeric substrate; and
producing said self-assembled surface irregularities on said exposed region by controlling the relative motion of said polymeric substrate and said beam when scanning the exposed region.

9. The system of claim 8, wherein said irradiation source comprises Focused Ion Beam (FIB) or Broad Ion Beam (BIB).

10. The system of claim 9, wherein said FIB or BIB comprises of Ga+ or Ar+ or O+.

11. The system of claim 9, wherein said polymeric substrate comprises a flat polydimethylsiloxane (PDMS) sheet.

12. The system of claim 11, wherein said irradiations source controls the morphology of said surface irregularities by tuning the number of FIB scans imposed on the PDMS sheet.

13. The system of claim 11, wherein said surface irregularities appear by moving the polymer sheet at a constant speed during FIB irradiation.

14. The system of claim 11, wherein said surface irregularities are formed using one or more maskless patterns.
